(19) United States
(12) Patent Application Publication
(10) Pub. No.: US 2007/0097176 A1
(43) Pub. Date: May 3, 2007

(54) Orifice plate coated with palladium nickel alloy

(76) Inventors: Kenneth Hickey, Leixlip NA (IE); Michelle Gerrity, Leixlip NA (IE); Karen Nolan, Leixlip NA (IE); Stafford Johnson, Hillsborough, NC (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/264,830

(22) Filed: Oct. 31, 2005

(51) Int. Cl. B41J 2/16; B41J 2/06

(52) U.S. Cl. 347/47; 347/55

(57) ABSTRACT

A coated orifice plate includes a core orifice plate having an orifice formed therein, and a palladium-nickel alloy plated on the core orifice plate.

### BACKGROUND

Ink-jet printing has become a popular way of recording images on various media surfaces, particularly paper, for a number of reasons, including, low printer noise, capability of high-speed recording, and multi-color recording. Additionally, these advantages of ink-jet printing can be obtained at a relatively low price to consumers. Though there has been great improvement in ink-jet printing, improvements are followed by increased demands from consumers for higher speeds, higher resolution, full color image formation, increased stability, etc.

### SUMMARY

In one aspect of the present system and method, a printhead orifice plate includes a core orifice plate having an orifice formed therein, and a palladium-nickel alloy plated on the core orifice plate.

In another embodiment, a method for forming a printhead orifice plate includes forming a core orifice plate, and plating the core orifice plate with a palladium-nickel alloy.

### BRIEF DESCRIPTION OF THE DRAWINGS

The accompanying drawing illustrates various embodiments of the present invention and is a part of the specification. The illustrated embodiments are merely examples of the present system and method and do not limit the scope thereof.

FIG. 1 is an exploded perspective view of an inkjet cartridge, according to one exemplary embodiment.

FIG. 2 is a magnified view of a metal orifice plate configuration, according to one exemplary embodiment.

FIG. 3 is a magnified cross sectional view of a thermal inkjet printhead including a coated metal orifice plate, according to one exemplary embodiment.

FIG. 4 is an exemplary method for coating a metal orifice plate with a palladium-nickel alloy, according to one exemplary embodiment.

FIG. 5 is a simple block diagram illustrating a plating cell, according to one exemplary embodiment.

FIG. 6 is a cross-sectional side view of a coated orifice plate, according to one exemplary embodiment.

FIG. 7 is a chart illustrating adhesion qualities of the present palladium-nickel alloy coating, according to one exemplary embodiment.

Throughout the drawing, identical reference numbers designate similar, but not necessarily identical, elements.

### DETAILED DESCRIPTION

The present specification discloses an inkjet cartridge with a metal orifice plate coated with an alloy of palladium-nickel. Specifically the present exemplary system and method discloses a low cost polycrystalline palladium-nickel alloy coating. The incorporation of a palladium-nickel alloy coating onto a metal orifice plate provides reduced formation costs, thinner coatings, and improved wear resistance. Further details of the present coating formulations and methods will be provided below.

Before particular embodiments of the present system and method are disclosed and described, it is to be understood that the present system and method are not limited to the particular process and materials disclosed herein as such may vary to some degree. It is also to be understood that the terminology used herein is used for the purpose of describing particular embodiments only and is not intended to be limiting, as the scope of the present system and method will be defined only by the appended claims and equivalents thereof.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1 wt % to about 20 wt % should be interpreted to include not only the explicitly recited concentration limits of 1 wt % to about 20 wt %, but also to include individual concentrations such as 2 wt %, 3 wt %, 4 wt %, and sub-ranges such as 5 wt % to 15 wt %, 10 wt % to 20 wt %, etc.

As used herein, “alloy” refers to any mixture containing two or more metallic elements or metallic and nonmetallic elements.

In the following description, for purposes of explanation, numerous specific details are set forth in order to provide a thorough understanding of the present system and method for forming an orifice plate coated with palladium-nickel alloy. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

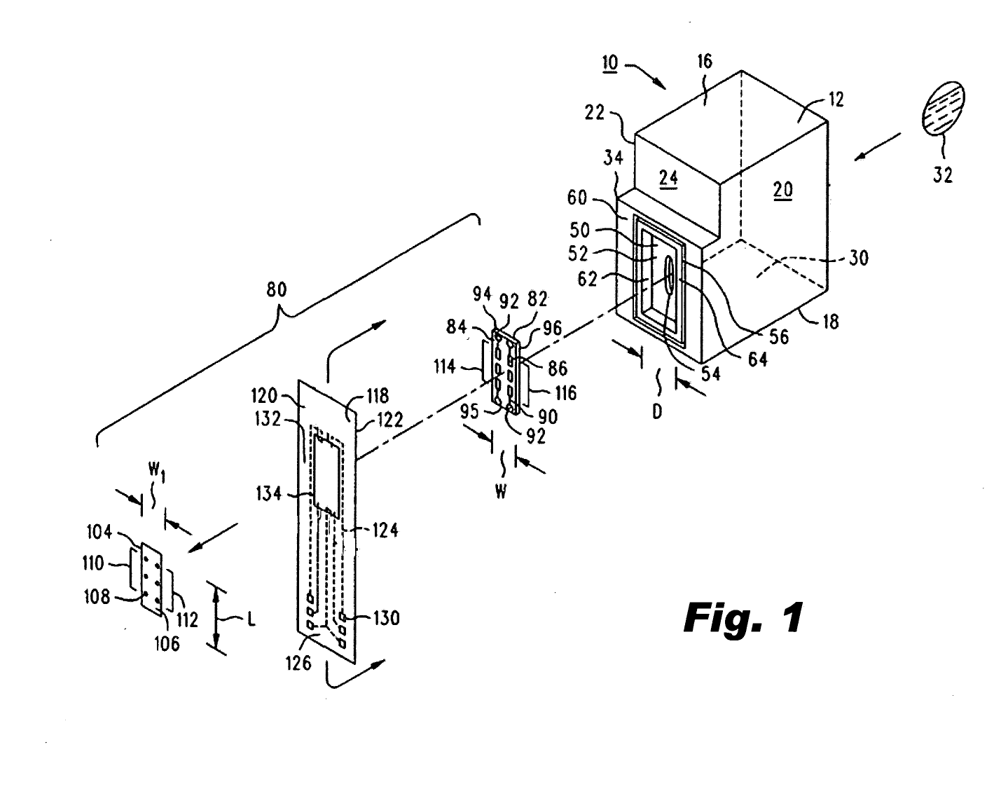

FIG. 1 illustrates a representative thermal inkjet cartridge (10), according to one exemplary embodiment. The present exemplary thermal inkjet cartridge (10) is presented herein for example purposes and is non-limiting. Further, the exemplary thermal inkjet cartridge (10) is shown in schematic format in FIG. 1, with more detailed information regarding the thermal inkjet cartridge (10) and its various features being provided in U.S. Pat. No. 4,500,895 to Buck et al.; U.S. Pat. No. 4,794,409 to Cowger et al.; U.S. Pat. No. 4,509,062 to Low et al.; U.S. Pat. No. 4,929,969 to Morris; U.S. Pat. No. 4,771,295 to Baker et al.; U.S. Pat. No. 5,278,584 to Keefe et al.; and the Hewlett-Packard Journal, Vol. 39, No. 4 (August 1988), all of which are incorporated herein by reference.

With continued reference to FIG. 1, the thermal inkjet cartridge (10) includes a housing (12) which may be manufactured of any number of materials including, but in no way limited to, plastic, metal, or a combination of both. The housing (12) further includes a top wall (16), a bottom wall (18), a first side wall (20), and a second side wall (22). In the embodiment of FIG. 1, the top wall (16) and the bottom wall (18) are substantially parallel to each other. Likewise, the first side wall (20) and the second side wall (22) are also substantially parallel to each other.

The housing (12) further includes a front wall (24). Surrounded by the front wall (24), top wall (16), bottom wall (18), first side wall (20), and second side wall (22) is an interior chamber or compartment (30) within the housing (12) (shown in phantom lines in FIG. 1) which is designed to retain a supply of an ink composition (32) therein (either in liquid [uncontained] form or retained within an absorbent foam-type member [not shown]). The front wall (24) further includes an externally-positioned, outwardly-extending printhead support structure (34) which includes a substantially rectangular central cavity (50) therein. The central cavity (50) includes a bottom wall (52) shown in FIG. 1 with an ink outlet port (54) formed therein. The ink outlet port (54) passes entirely through the housing (12) and, as a result, communicates with the compartment (30) inside the housing (12) so that ink materials can flow outwardly from the compartment (30) through the ink outlet port (54).

Also positioned within the central cavity (50) is a rectangular, upwardly-extending mounting frame (56), the function of which will be discussed below. As schematically shown in FIG. 1, the mounting frame (56) is substantially even (flush) with the front face (60) of the printhead support structure (34). The mounting frame (56) may, according to one exemplary embodiment, include dual, elongate side walls (62, 64).

With continued reference to FIG. 1, fixedly secured to the housing (12) of the ink cartridge (10) (e.g. attached to the outwardly-extending printhead support structure (34)) is a printhead (80). For ease of describing the present exemplary system and method, and in accordance with conventional terminology, the present exemplary printhead (80) will be described in the context of a structure having two main components secured together, with various sub-components positioned there between. According to one exemplary embodiment, the first main component of the printhead (80) includes a substrate (82) preferably manufactured from silicon. Secured to the upper surface (84) of the substrate (82) using standard thin film fabrication techniques is a plurality of individually-energizable thin-film resistors (86) which function as “ink ejectors” and are preferably fabricated from a tantalum-aluminum composition known in the art for resistor construction. Only a small number of resistors (86) are shown in the schematic representation of FIG. 1, with the resistors (86) being presented in enlarged format for the sake of clarity. Also provided on the upper surface (84) of the substrate (82) using conventional photolithographic techniques is a plurality of metallic conductive traces (90) (e.g. circuit elements) which electrically communicate with the resistors (86). The conductive traces (90) also communicate with multiple metallic pad-like contact regions (92) positioned at the ends (94, 95) of the substrate (82) on the upper surface (84). These components which, in combination, are collectively designated herein as a resistor assembly (96) are configured to facilitate selective ejection of an ink composition (32) from the printhead (80), as will be discussed further below.

According to one exemplary embodiment, many different materials and design configurations may be used to construct the resistor assembly (96). According to one exemplary embodiment, the resistor assembly (96) may be approximately 0.5 inches long, and will likewise contain approximately 300 resistors (86), thereby enabling a print resolution of 600 dots per inch (“DPI”). The substrate (82) containing the resistors (86) thereon will preferably have a width “W” (FIG. 1) which is less than the distance “D” between the side walls (62, 64) of the mounting frame (56). As a result, ink flow passageways are formed on both sides of the substrate (82) so that ink flowing from the ink outlet port (54) in the central cavity (50) can ultimately come in contact with the resistors (86) for selective ejection of an ink composition (32). Additionally, the substrate (82) may include a number of other components thereon (not shown) depending on the type of ink cartridge (10) under consideration. For example, according to one exemplary embodiment, the substrate (82) may likewise include a plurality of logic transistors for precisely controlling operation of the resistors (86), as well as a “demultiplexer” of conventional configuration as discussed in U.S. Pat. No. 5,278,584. The demultiplexer is used to demultiplex incoming multiplexed signals and thereafter distribute these signals to the various thin film resistors (86). The use of a demultiplexer for this purpose enables a reduction in the complexity and quantity of the circuitry (e.g. contact regions (92) and traces (90)) formed on the substrate (82).

Continuing with FIG. 1, a film-type flexible circuit member (118) is provided in connection with the cartridge (10). According to one exemplary embodiment, the film-type flexible circuit member (118) is configured to “wrap around” the outwardly-extending printhead support structure (34) in the completed ink cartridge (10). The flexible circuit member (118) is secured to the printhead support structure (34) by adhesive affixation using conventional adhesive materials (e.g. epoxy resin compositions known in the art for this purpose). The flexible circuit member (118) enables electrical signals to be delivered and transmitted from the printer unit (not shown) to the resistors (86) (or other ink ejectors) on the substrate (82). The film-type flexible circuit member (118) further includes a top surface (120) and a bottom surface (122). A plurality of metallic (e.g. gold-plated copper) circuit traces (124) are formed on the bottom surface (122) of the circuit member (118) as shown in dashed lines in FIG. 1. Many different circuit trace patterns may be employed on the bottom surface (122) of the flexible circuit member (118), with the specific pattern depending on the particular type of ink cartridge (10) and printing system under consideration. Also provided at position (126) on the top surface (120) of the circuit member (118) is a plurality of metallic (e.g. gold-plated copper) contact pads (130). The contact pads (130) communicate with the underlying circuit traces (124) on the bottom surface (122) of the circuit member (118) via openings or “vias” (not shown) through the circuit member (118). During use of the ink cartridge (10) in a printer unit, the pads (130) come in contact with corresponding printer electrodes in order to transmit electrical control signals from the printer unit to the contact pads (130) and traces (124) on the circuit member (118) for ultimate delivery to the resistor assembly (96). Positioned within the middle region (132) of the film-type flexible circuit member (118) is a window (134) which is sized to receive an orifice plate (104) therein.

Securely affixed to the upper surface (84) of the substrate (82), with a number of intervening material layers therebetween including a barrier layer as outlined below, is a second main component of the printhead (80). Specifically, an orifice plate (104) is provided as shown in FIG. 1 which is used to distribute the selected ink compositions to a designated print media material (e.g. paper). In accordance with the present exemplary system and method, the orifice plate (104) includes a panel member (106) (shown schematically in FIG. 1) which is manufactured from at least one metal or plastic core composition coated by a palladium-nickel alloy. The specific materials, ratios, dimensions, as well as additional details involving the method of depositing the palladium-nickel alloy on the orifice plate (104) will be provided in detail below. In an exemplary and non-limiting representative embodiment, the orifice plate (104) may have a length “L” of approximately 5-30 mm and a width “W₁” of approximately 3-15 mm. While the above length and width value are presented for ease of explanation, the present exemplary system and method may be applied to orifice plates having any physical parameters.

The orifice plate (104) further includes at least one and preferably a plurality of openings or “orifices” (108). The exemplary orifices (108) are shown in enlarged format in FIG. 1 for illustrative purposes. Each orifice (108) in one exemplary embodiment may have a diameter of approximately 0.01-0.05 mm. In the completed printhead (80), all of the components listed above are assembled so that each of the orifices (108) is aligned with at least one of the resistors (86) (e.g. “ink ejectors”) on the substrate (82). As result, selective energization of a given resistor (86) will cause ink expulsion from the desired orifice (108) through the orifice plate (104). As mentioned, the present system and method may be applied to an orifice plate (104) have any number of sizes, shapes, or dimensional characteristics. Additionally, the orifice plate (104) in connection with the present exemplary system and method shall not be restricted to any number or arrangement of orifices (108). Rather, according to one exemplary embodiment, the orifices (108) may be arranged in two rows (110, 112) on the panel member (106) associated with the orifice plate (104). If this arrangement of orifices (108) is employed, the resistors (86) on the resistor assembly (96) (e.g. the substrate (82)) will also be arranged in two corresponding rows (114, 116) so that the rows (114, 116) of resistors (86) are in substantial registry with the rows (110, 112) of orifices (108). Further information concerning this type of metallic orifice plate system is provided in, for example, U.S. Pat. No. 4,500,895 to Buck et al. which is incorporated herein by reference.

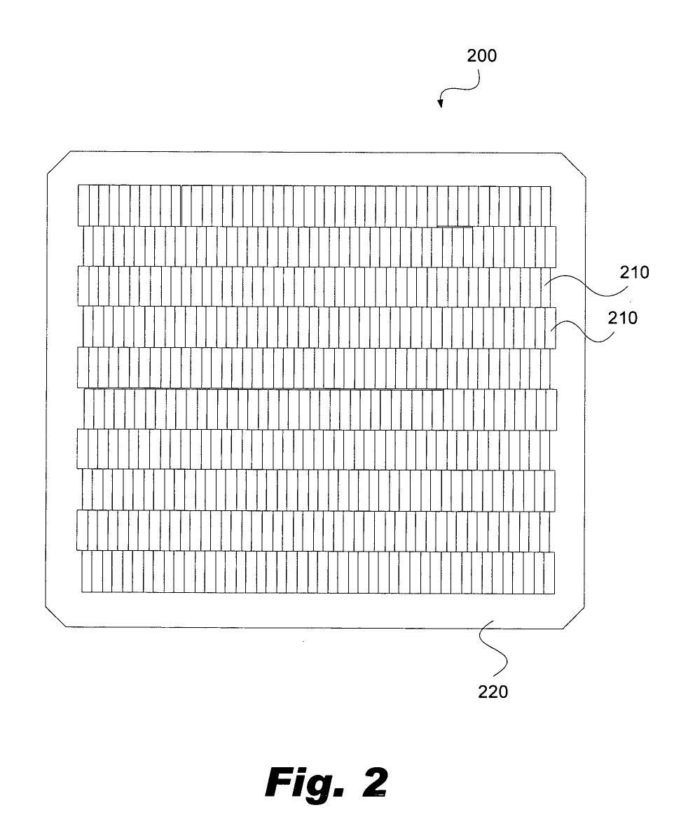

Alternatively, the orifice plate (104) may be a sheet orifice plate (200) as illustrated in FIG. 2. As shown, the sheet orifice plate (200) has a multitude of intercoupled orifice plates (210) surrounded by a peripheral frame (220) that provides structural support and alignment for the sheet orifice plate. According to this exemplary embodiment, each of the intercoupled orifice plates (210) may have a number of nozzle arrays (not shown) formed therein for selective dispensing of an ink composition.

Regardless of the orifice plate configuration, the orifice plate of the present exemplary system and method includes a plating material plated over a substrate. According to this exemplary embodiment, the plating material is plated onto the substrate in order to add wear and corrosion resistance to the core. Specifically, thermal inks include a number of reactive materials that can cause corrosion of the orifice plate if not plated. Further details of the core material and the plating material will be provided below.

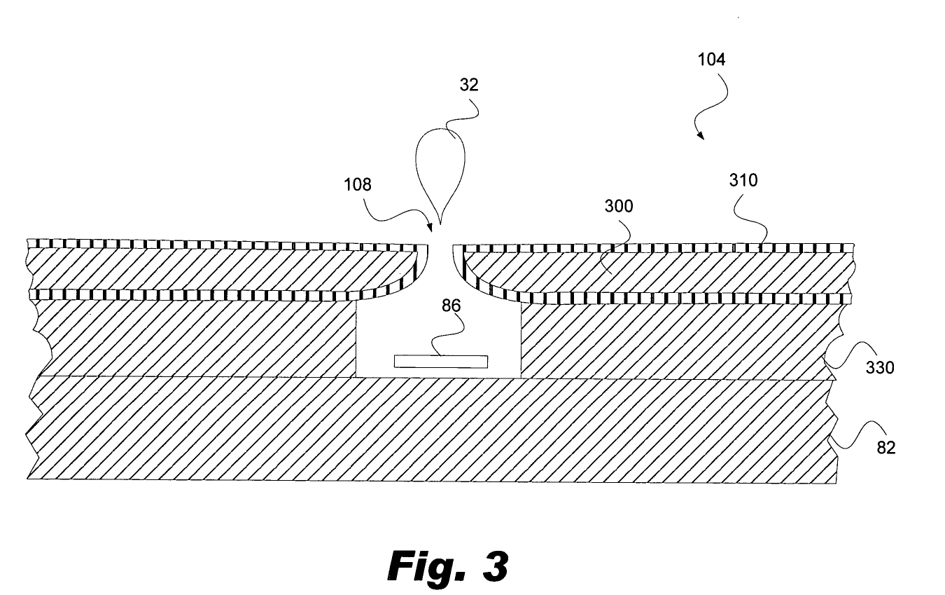

FIG. 3 illustrates a magnified cross-sectional view of the orifice plate (104) coupled to a resistor assembly (96), according to one exemplary embodiment. As illustrated in FIG. 3, the orifice plate (104) is disposed on an intermediate barrier layer (330), which is subsequently coupled to a resistor assembly substrate (82). The orifice plate (104) includes an orifice (108) that extends through the orifice plate. Generally, the orifice (108) is conical in shape as illustrated in FIG. 3. In addition to the orifice (108) formed in the orifice plate (104), a space is formed in the barrier layer (330), corresponding to the orifice, and a resistor (86) coupled to the resistor assembly substrate (82). According to one exemplary embodiment, the resistor may be selectively activated to cause the discharge of an ink composition (32) in the form of a droplet.

Mechanical contact with the orifice plate (104) may cause a scratch or other wear on the orifice plate, creating possible mis-directions of subsequently fired ink drops or otherwise reducing the accuracy of the printhead (80; FIG. 1). Additionally, solvents and other harsh materials that are often included in the ink composition (32) may cause corrosion on the orifice plate (104). Consequently, as illustrated in FIG. 3, the orifice plate includes a core substrate (300) coated with a plating material (310). According to one exemplary embodiment, the core substrate (300) is a relatively soft, yet workable material such as nickel. The core substrate (300) is coated with the plating material (310) to reduce wear and corrosion. Traditionally, such non-reactive materials as gold and palladium have been used to form the plating material. However, these materials are relatively expensive and must be coated at a thickness that greatly increases the materials cost of the orifice plate (104).

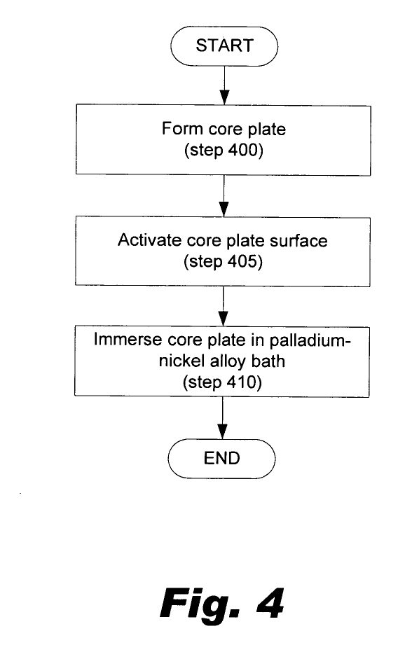

In contrast to traditional plating materials, the present exemplary orifice plate is coated with a palladium-nickel alloy coating on both the upper and lower surfaces of the orifice plate. The incorporation of a palladium-nickel alloy in the present exemplary system and method results in a plating material (310) that can be made thinner than traditional gold and palladium coatings, while providing equivalent corrosion resistance and improved wear resistance. Consequently, lower cost orifice plates with improved wear resistance may be formed. Exemplary methods for depositing a palladium-nickel alloy plating material (310) on a core (300) orifice plate (104) will be provided below with reference to FIGS. 4 through 6.

FIG. 4 illustrates an exemplary method for plating a palladium-nickel alloy plating material (310) onto a core orifice plate (104), according to one exemplary embodiment. As illustrated in FIG. 4, the exemplary plating method begins by forming a core plate (step 400). Once the core plate is formed, the surface of the core plate is activated to remove any oxides (step 405) and then may be immersed in a palladium-nickel alloy bath to form the palladium-nickel alloy plating material (step 410). Further details of each of the plating steps will be provided below.

As illustrated the first step of the present exemplary method for plating a palladium-nickel alloy plating material (310) onto a core orifice plate (104) includes forming the core plate (step 400). As mentioned previously with reference to FIGS. 1 and 2, the core orifice plate may assume any number of geometries including, but in no way limited to, a strip orifice plate (104; FIG. 1) or a sheet orifice plate (200; FIG. 2). According to one exemplary embodiment, the core orifice plate may be formed of any number of easily formable materials including, but in no way limited to, nickel. Additionally, the core orifice plate may be formed by any number of formation methods including, but in no way limited to, electroforming, stamping, molding, and the like.

Once the core orifice plate is formed (step 400), the surface of the core plate may be activated to remove any oxides that may reduce adhesion of the subsequently deposited palladium-nickel alloy (step 405). According to one exemplary embodiment, a nickel core orifice plate may be dipped in a hydrochloric acid bath to remove any oxides present on its surface.

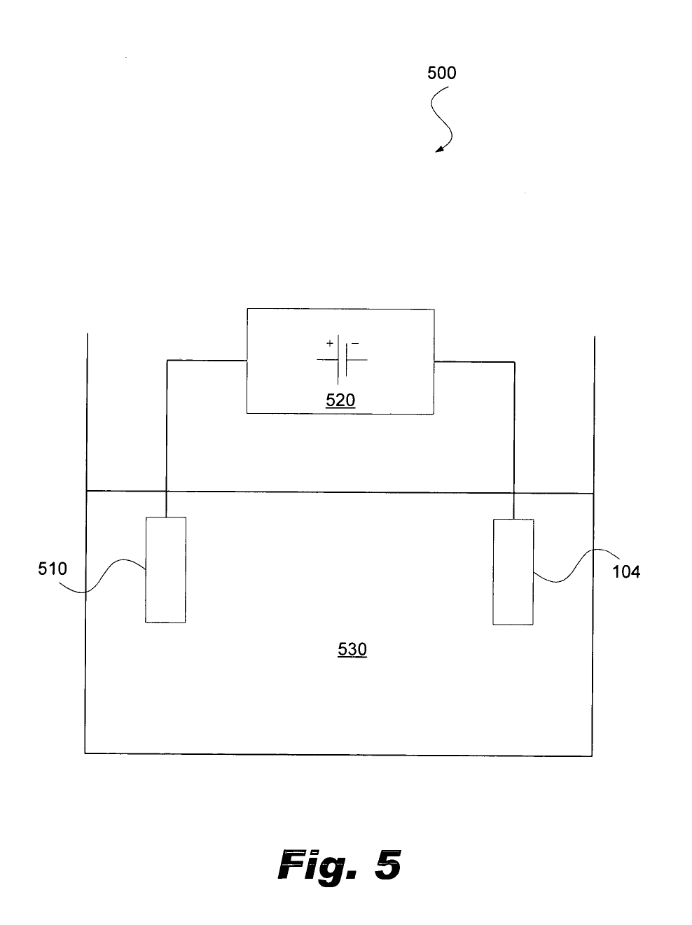

Once the surface is activated (step 405), the orifice plate (104) may be plated with the present exemplary palladium-nickel alloy (step 410). According to one exemplary embodiment, plating the core orifice plate with a palladium-nickel alloy includes immersing the core orifice plate (104; FIG. 1) into a single plating bath. Additionally, the present palladium-nickel alloy plating method does not necessitate a strike acid adhesion layer which is necessary for the traditional palladium plating chemistry. According to one exemplary embodiment, the palladium-nickel alloy is formed by electrodepositing the alloy onto the core orifice plate from a single plating bath containing a nickel (II) and palladium (II) ion solution. According to one exemplary embodiment, the core orifice plate (104) or orifice sheet (200) forms the cathode of an electrolytic plating cell (500), as illustrated in FIG. 5. There is also an inert anode (510) made of materials including, but in no way limited to, platinum coated niobium or titanium. A power supply (520) gives a constant current across the plating solution (530). According to one exemplary embodiment, the pH of the nickel (II) and palladium (II) ion solution (530) is controlled at a pH of 7.5 with an ammonia or similar buffer. Additionally, the single plating bath may contain any number of surfactants, brighteners, and/or other additives.

As mentioned, the core orifice plate (104; FIG. 1) is immersed in the plating bath (530). According to one exemplary embodiment, the temperature of the bath is maintained at approximately 55° C. to minimize intrinsic mechanical stresses. Once inserted into the plating bath (530), a plating current is provided to the bath to initiate the plating process. According to one exemplary embodiment, a current density of approximately 2.5 A/dm2 is provided to form a 70:30 palladium-nickel alloy composition on the core orifice plate (104). However, the present exemplary system and method may be practiced with an alloy having any ratio of palladium to nickel. According to one exemplary embodiment the palladium-nickel alloy composition on the core orifice plate may have a composition between approximately 50 and 80 percent palladium.

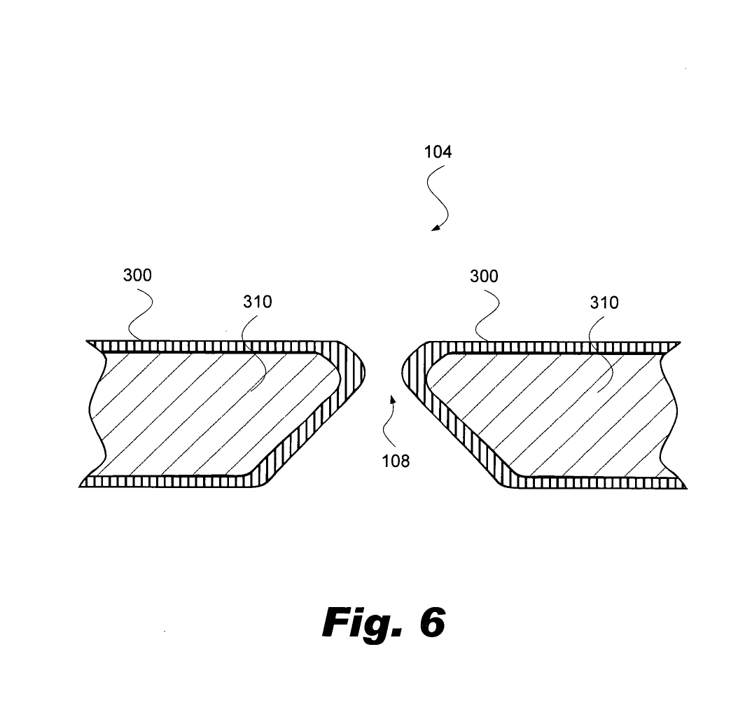

According to the present exemplary method, the palladium-nickel alloy coating is formed on both the upper and lower surfaces of the orifice plate (104), as illustrated in FIG. 6. As illustrated in FIG. 6, the core orifice plate (300) receives a palladium-nickel alloy plating material (310) on all exposed sides. Due to the material properties of the palladium-nickel alloy, the coating may be made thinner than traditional gold and palladium coatings due to a reduced porosity, adequate corrosion resistance, equivalent core adhesion, and better ware resistance. According to one exemplary embodiment, palladium-nickel coatings formed by the present exemplary method may be as thin as approximately 0.5 μm. According to one exemplary embodiment, the use of an alloy coated at reduced thicknesses can also reduce the cost of coating materials by up to 70% when compared to traditional palladium coatings.

Further, according to one alternative embodiment of the present exemplary system and method, any number of adhesion promoting treatments may be applied to the plated orifice plate (104). According to one exemplary embodiment, the adhesion promoting treatment may include, but is in no way limited to, TaPs. Further details of the use and effect of adhesion promoting treatments may be found in U.S. Pat. No. 6,054,011, which patent is incorporated herein by reference in its entirety. The present exemplary system and method may be practiced either with or without the adhesion promoting treatments.

### EXAMPLE

The above-mentioned exemplary method was used to electroplate a number of nickel orifice plate sheets with a palladium-nickel alloy (70:30). The alloy chemistry is called Pallnic II as supplied by Metalor. During formation, only one plating bath was used and no strike acid adhesion layer was used. The chemistry of the plating bath consisted of a nickel (II) and a palladium (II) ion solution. The pH of the solution was controlled at a pH of approximately 7.5 by the inclusion of an ammonia buffer. Additionally, surfactant, brightener, and other additives were included in the solution. The temperature of the bath was 55° C., and the current density used was 2.5 A/dm2. The composition illustrated in Table 1 below gave approximately a 70:30 alloy composition.

TABLE 1

| Pallnic ™ II | | Quantity per Liter | |
|---|---|---|---|
| Pallnic ™ II | Palladium Metal | 7.4 | g. |
| Pallnic ™ | Brightener No. 1 | 10 | mls |
| Pallnic ™ | Conducting Salts | 50 | g |
| Pallnic ™ | Additive Solution | 20 | mls |
| Pallnic ™ | Nickel Replenisher (100 g/l) | 90 | mls for 9 g/l Ni |
| Pallnic ™ | Wetting Agent | 10 | mls |

The alloy produced with the chemistry and settings illustrated in Table 1 above was bright and very similar in appearance to pure palladium. The stress for the 70:30 alloy was 1.2+/−0.9 Gpa as measured with stress tabs. This compares with 19+/−7 Gpa for traditional pure palladium. The material properties of the alloy are harder compared to gold and palladium giving it better ware resistance. The porosity is also much less compared with gold and palladium of the same thickness. Specifically, the porosity of gold 1 μm thick is approximately equivalent to palladium nickel alloy 0.5 μm thick. Palladium at 1 μm thick has a porosity of approximately 15 pores/cm², which is close to that of 0.5 μm palladium nickel alloy which has a tested porosity of approximately 20 pores/cm².

The corrosion resistance of the palladium-nickel alloy plating was subsequently tested in a subset of reference inks. Gold coupons plated with the palladium-nickel alloy were soaked in the various inks for 28 days at 70° C. The results compare very well with gold and palladium under the same conditions.

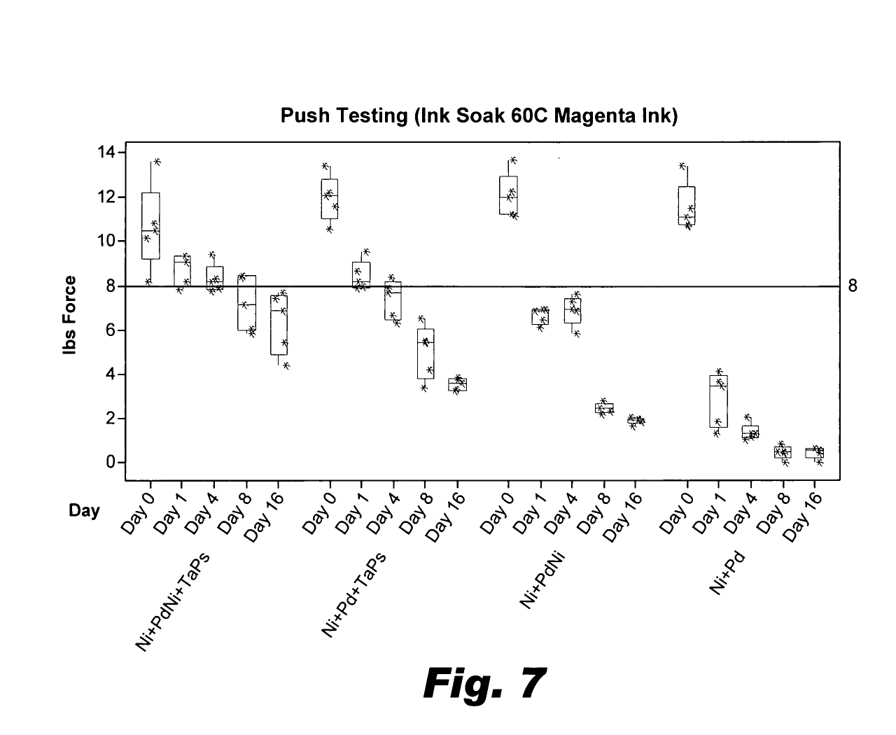

In order to assess the adhesion of the palladium-nickel orifice plate (140) to the intermediate barrier layer (330), an experiment was performed attaching palladium-nickel alloy and pure palladium coated orifice plates to a single wafer for comparison. A second wafer was also made including the same plates coated with TaPs. TaPs is an adhesion promoting treatment to the underside of the orifice plate. Tantalum is sputtered onto the underside and then a silane coupling agent (SCA) is spun onto the plate. The wafers were then placed in a 16 day ink soak at approximately 60° C. At intervals over the 16 day soaking period, the plates were tested for adhesion. The results demonstrated that the palladium-nickel coated orifice plates have equivalent adhesion relative to plates with palladium overcoat, as illustrated in FIG. 7.

In conclusion, the present palladium-nickel alloy coating has equivalent corrosion resistance in our reference inks. The alloy also is less porous and has better ware resistance compared to traditional gold and palladium coatings. Due to the adequate corrosion and improved wear resistance, the palladium-nickel overcoat can be thinner than traditional coatings. Consequently, approximately a 70% cost saving in direct materials can be realized.

The preceding description has been presented only to illustrate and describe exemplary embodiments of the present system and method. It is not intended to be exhaustive or to limit the system and method to any precise form disclosed. Many modifications and variations are possible in light of the above teaching. It is intended that the scope of the system and method be defined by the following claims.

1. A printhead orifice plate comprising:
a core orifice plate having an orifice formed therein; and
a palladium-nickel alloy plated on said core orifice plate.

2. The printhead orifice plate of claim 1, wherein said palladium-nickel alloy comprises between approximately 50 and 80 percent palladium.

3. The printhead orifice plate of claim 2, wherein said palladium nickel alloy comprises approximately 70 parts palladium to 30 parts nickel.

4. The printhead orifice plate of claim 1, wherein said core orifice plate comprises nickel.

5. The printhead orifice plate of claim 1, wherein said core orifice plate comprises a sheet orifice plate.

6. The printhead orifice plate of claim 1, wherein said palladium-nickel alloy comprises a thickness of approximately 0.5 μm.

7. A printhead comprising:
a resistor assembly; and
an orifice plate assembly coupled to said resistor assembly;
wherein said orifice plate assembly includes a core orifice plate having an orifice formed therein and a palladium-nickel alloy plated on said core orifice plate.

8. The printhead of claim 7, wherein said palladium-nickel alloy comprises between approximately 50 and 80 percent palladium.

9. The printhead of claim 8, wherein said palladium-nickel alloy comprises approximately 70 parts palladium to 30 parts nickel.

10. The printhead of claim 7, wherein said core orifice plate comprises nickel.

11. The printhead orifice plate of claim 7, wherein said core orifice plate comprises a sheet orifice plate.

12. The printhead orifice plate of claim 7, wherein said palladium-nickel alloy comprises a thickness of approximately 0.5 μm.

13. The printhead orifice plate of claim 7, wherein said palladium-nickel alloy further comprises a brightener.

14. A printhead orifice plate comprising:
a core orifice plate having an orifice formed therein; and
a means for coating said orifice plate to increase wear and corrosion resistance of said core orifice plate;
wherein said means for coating said orifice plate comprises a palladium-nickel alloy.

15. The printhead orifice plate of claim 14, wherein said palladium-nickel alloy comprises between approximately 50 and 80 percent palladium.

16. The printhead orifice plate of claim 15, wherein said palladium-nickel alloy comprises approximately 70 parts palladium to 30 parts nickel.

17. The printhead orifice plate of claim 14, wherein said core orifice plate comprises nickel.

18. The printhead orifice plate of claim 14, wherein said core orifice plate comprises a sheet orifice plate.

19. A method of forming a printhead orifice plate comprising:
forming a core orifice plate; and
plating said core orifice plate with a palladium-nickel alloy.

20. The method of claim 19, wherein forming said core orifice plate comprises forming a nickel core orifice plate.

21. The method of claim 20, wherein forming said core orifice plate comprises stamping or electroforming a sheet of nickel.

22. The method of claim 19, wherein plating said core orifice plate with a palladium-nickel alloy comprises:
immersing said core orifice plate in a single plating bath containing a nickel (II) and a palladium (II) ion solution; and
providing a plating current to said single plating bath.

23. The method of claim 22, wherein said single plating bath containing a nickel (II) and a palladium (II) ion solution is controlled at a pH of approximately 7.5.

24. The method of claim 22, wherein said single plating bath containing a nickel (II) and a palladium (II) ion solution further comprises surfactants.

25. The method of claim 22, wherein said single plating bath containing a nickel (II) and a palladium (II) ion solution further comprises brighteners.

26. The method of claim 22, wherein said single plating bath is maintained at approximately 55° C.

27. The method of claim 22, wherein said providing a plating current in said bath comprises providing a current density of approximately 2.5 A/dm2 in said bath.

28. The method of claim 22, wherein said providing a plating current in said bath generates a palladium-nickel layer on said plating orifice approximately 0.5 μm thick.

29. (canceled)

30. The method of claim 19, further comprising activating said core orifice plate prior to said plating.

31. The method of claim 19, further comprising coating said core orifice plate with an adhesion promoting treatment prior to said plating.

32. A printhead orifice plate, wherein said printhead orifice plate comprises a layer of palladium-nickel formed by a single plating bath.

33. The printhead orifice plate of claim 32, wherein said layer of palladium-nickel comprises approximately 70 parts palladium to 30 parts nick

34. The printhead orifice plate of claim 32, wherein said layer of palladium-nickel comprises a thickness of approximately 0.5 μm.

35. The printhead orifice plate of claim 32, wherein said orifice plate comprises a sheet orifice plate.
